(19) United States
(12) Patent Application Publication
(10) Pub. No.: US 2003/0009495 A1
(43) Pub. Date: Jan. 9, 2003

(54) Systems and methods for filtering electronic content

(76) Inventor: Akli Adjaoute, Joinville le Pont (FR)

Correspondence Address: FISH & NEAVE, 1251 AVENUE OF THE AMERICAS, 50TH FLOOR, NEW YORK, NY, 10020-1105, US

(21) Appl. No.: 09/895,603

(22) Filed: Jun. 29, 2001

(51) Int. Cl. G06F 17/21

(52) U.S. Cl. 707/501.1; 707/530

(57) ABSTRACT

Systems and methods for filtering electronic content according to thesaurus-based contextual analysis of the content are described. The systems and methods of the present invention consist of a list-based and context-based filtering software solution that can be used on personal computers, local area networks, local or remote proxy servers, Internet service providers, or search engines to control access to inappropriate content. Access to content is controlled by a filtering software administrator, who determines which sites and which contexts to restrict.

### FIELD OF THE INVENTION

The present invention relates generally to electronic content filtering. More specifically, the present invention provides systems and methods for filtering electronic content according to a thesaurus-based contextual analysis of the content.

### BACKGROUND OF THE INVENTION

The explosion of telecommunications and computer networks has revolutionized the ways in which information is disseminated and shared. At any given time, massive amounts of digital information are exchanged electronically by millions of individuals worldwide with many diverse backgrounds and personalities, including children, students, educators, business men and women, and government officials. The digital information may be quickly accessed through the World Wide Web (hereinafter “the web”), electronic mail, or a variety of electronic storage media such as hard disks, CDs, and DVDs.

While this information may be easily distributed to anyone with access to a computer or to the web, it may contain objectionable and offensive material not appropriate to all users. In particular, adult content displayed on the web may not be appropriate for children or employees during their work hours, and information on the web containing racial slurs may even be illegal in some countries.

Information is accessed on the web through a multimedia composition called a “web page.” Web pages may contain text, audio, graphics, imagery, and video content, as well as nearly any other type of content that may be experienced through a computer or other electronic devices. Additionally, web pages may be interactive, and may contain user selectable links that cause other web pages to be displayed. A group of one or more interconnected and closely related web pages is referred to as a “web site.” Typically, web sites are located on one or more “web servers”, and are displayed to users on a “web browser window” by “web browser software” such as Internet Explorer, available from Microsoft Corporation, of Redmond, Wash., that is installed on the users' computer.

By far, it has been estimated that the most frequently visited web sites are those displaying adult content. With the number of web sites displaying adult and other inappropriate content growing rapidly, it has become increasingly difficult for parents and other users to screen or filter out information they may find offensive. As a result, a number of filtering systems have been developed to address the need to control access to offensive information distributed on the web or on other electronic media including CDs, DVDs, etc. These systems can be classified into one or a combination of four major categories: (1) rating-based systems; (2) list-based systems; (3) keyword-based systems; and (4) context-based systems.

Rating-based systems originated with a proposal by the World Wide Web Consortium to develop a system for helping parents and other computer users to block inappropriate content according to ratings or labels attached to web sites by rating service organizations and other interest groups. The proposal resulted in the development of the Platform for Internet Content Selection (PICS), which consists of a set of standards designed to provide a common format for rating service organizations and filtering software to work together. The PICS standard enables content providers to voluntarily label the content they create and distribute. In addition, the PICS standard allows multiple and independent rating service organizations to associate additional labels with content created and distributed by others. The goal of the PICS standard is to enable parents and other computer users to use ratings and labels from a diversity of sources to control the information that children or other individuals under their supervision receive.

Rating service organizations may select their own criteria for rating a web site, and filtering software may be configured to use one or more rating criteria. Rating criteria for filtering out Internet content typically consist of a series of categories and gradations within those categories. The categories that are used are chosen by the rating service organizations, and may include topics such as “sexual content”, “race”, or “privacy.” Each of these categories may be described along different levels of content, such as “romance; “no sexual content”, “explicit sexual content”, or somewhere in between, similar to the motion picture ratings used to classify movies for different age groups.

An example of a ratings-based content filtering software is the SuperScout Web filter developed by Surf Control, Inc., of Scotts Valley, Calif. SuperScout uses neural networks to dynamically classify web sites according to their content into different categories. These categories include “adult/sexually explicit”, “arts and entertainment”, “hate speech”, and “games”, among others. The system contains a rules engine to enable users to define rules that govern Internet access to the different web site categories.

While rating-based systems allow computer users to rely on trusted authorities to categorize Internet content, they assume that the same rating criteria is acceptable to all users, regardless of their ideologies, personal tastes, and standards. To reflect the individual preferences of each user, the rating criteria must be customizable and constantly updated. However, maintaining up-to-date ratings on many web sites is nearly impossible, since sites change their content constantly without necessarily changing their ratings. Some web sites may even have content generated on the fly, further complicating the maintenance of current ratings.

An alternative to using rating-based systems to classify and filter out inappropriate content involves using list-based systems to maintain lists of acceptable and/or unacceptable URLs, newsgroups, and chat rooms. The lists are usually resident in a database that is accessed by filtering software each time a computer user visits a web site, a newsgroup, or a chat room. The lists may be manually created by members of rating organizations, filter software vendors, parents, and other users of the filtering software. Alternatively, the lists may be created dynamically by using sophisticated technologies such as neural networks and software agents that analyze web sites to determine the appropriateness of the sites' content.

Examples of list-based filtering systems include Net Nanny, developed by Net Nanny Software International, Inc., of Vancouver, BC, Cyber Patrol, developed by Surf Control, Inc., of Scotts Valley, Calif., and Cyber Sitter, developed by Solid Oak Software, Inc., of Santa Barbara, Calif. These systems maintain lists of inappropriate and objectionable web sites that may be selected by users for blocking. The lists are compiled by professional researchers that constantly browse the web, newsgroups, and chat rooms to analyze their content.

However, there are several drawbacks associated with filtering content solely based on lists of sites to be blocked. First, these lists are incomplete. Due to the decentralized nature of the Internet, it's practically impossible to search all web sites, newsgroups, and chat rooms for “objectionable” material. Even with a paid staff person searching for inappropriate sites, it is a daunting task to identify all sites that meet their blocking criteria. Second, since new web sites are constantly appearing, even regular updates from filtering software vendors will not block all inappropriate sites. Each updated list becomes obsolete as soon as it is released, since any site that appears after the update will not be on the list and will not be blocked. Third, the volatility of individual sites already on a list does not guarantee the presence of the site on the list. Inappropriate material might be removed from a site soon after the site is added to a list of blocked sites. In addition, mirror sites may mask the actual URL on a list or the URL of a blocked site may be easily changed. Finally, users may not have access to the criteria used to create the lists of blocked sites and are unable to examine which sites are blocked and why.

To address the dynamic nature of Internet content, keyword-based filtering systems have been developed. These systems filter the content based on the presence of inappropriate or offending keywords or phrases. When Internet content is requested, keyword-based systems automatically scan the sites for any of the offending words and block the sites in which the offending words are found. The offending words may be included in a predefined list offered by the filtering software vendor or specified by the parent or user controlling Internet access. The predefined list contains keywords and phrases to be searched for every time a web site is browsed by an user. Similar to list-based systems, keyword-based systems must be frequently updated to reflect changes in the user's interest as well as changes in terminology in Internet content. An example of a keyword-based filtering system is the Cyber Sentinel system developed by Security Software Systems, of Sugar Grove, Ill.

Keyword-based systems often generate poor results, and are likely to block sites that should not be blocked while letting many inappropriate sites pass through unblocked. Because the systems search for individual keywords only, they cannot evaluate the context in which those words are used. For example, a search might find the keyword “breast” on a web page, but it cannot determine whether that word was used in a chicken recipe, an erotic story, a health related site, or in some other manner. If this keyword is used to filter out pornographic web sites, breast cancer web sites will also be filtered out. Furthermore, keyword-based systems are not able to block pictures. A site containing inappropriate pictures will be blocked only if the text on the site contains one or more words from the list of words to be blocked.

To make keyword-based systems more effective, context-based systems have been develop to perform a contextual analysis of the site to be blocked. A contextual analysis is applied to find the context in which the words in the site are used. The context may be found based on a built-in thesaurus or based on sophisticated natural language processing techniques. A built-in thesaurus is essentially a database of words and their contexts. For example, the word “apple” may have as contexts the words “fruit”, “New York”, or “computer.” By using contextual analysis to evaluate the appropriateness of a particular site, the main idea of the site's content may be extracted and the site may be blocked accordingly.

An example of a context-based system is the I-Gear web filter developed by Symantec Corporation, of Cupertino, Calif. This system employs a multi-lingual, context-sensitive filtering technology to assign a score to each web page based on a review of the relationship and proximity of certain inappropriate words to others on the page. For example, if the word “violent” appears next to the words “killer” and “machine gun”, the filtering technology may interpret the site to contain violent material inappropriate to children and assign it a high score. If the score exceeds a threshold, the site is blocked.

While I-Gear and other context-based systems are more effective than individual keyword-based systems, they lack the ability to filter electronic content other than text on web pages. These systems are not guaranteed to block a site containing inappropriate pictures, and cannot block inappropriate content stored in other electronic forms, such as content in DVDs, CDs, and word processing documents, among others. Furthermore, the context-sensitive technology provided in the I-Gear system does not employ a thesaurus to identify the many possible contexts of words on web pages that may be used to convey objectionable and offensive content. By using the proximity of certain inappropriate words to others to determine their relationship, the context-sensitive filtering technology in the I-Gear system is limited to filtering only those sites in which inappropriate words are close together.

In view of the foregoing, it would be desirable to provide systems and methods for filtering electronic content according to a thesaurus-based contextual analysis of the content.

It further would be desirable to provide systems and methods for filtering electronic content that are able to extract the main idea of the content by determining the contexts in which words in the content are used and block access to the content if the main idea is part of a list of inappropriate contexts.

It still further would be desirable to provide systems and methods for filtering electronic content on web sites containing inappropriate pictures and inappropriate words spread out across links on the web sites.

It also would be desirable to provide systems and methods for filtering content on web sites based on a list of inappropriate sites and a dynamic contextual analysis of the web site using a thesaurus.

### SUMMARY OF THE INVENTION

In view of the foregoing, it is an object of the present invention to provide systems and methods for filtering electronic content according to a thesaurus-based contextual analysis of the content.

It is another object of the present invention to provide systems and methods for filtering electronic content that are able to extract the main idea of the content by determining the contexts in which words in the content are used and block access to the content if the main idea is part of a list of inappropriate contexts.

It is a further object of the present invention to provide systems and methods for filtering electronic content on web sites containing inappropriate pictures and inappropriate words spread out across links on the web sites.

It is also an object of the present invention to provide systems and methods for filtering content on web sites based on a list of inappropriate sites and a dynamic contextual analysis of the web site using a thesaurus.

These and other objects of the present invention are accomplished by providing systems and methods for filtering electronic content in web sites, CDs, DVDs, and other storage media using a thesaurus-based contextual analysis of the content. The systems and methods consist of a list-based and context-based filtering software solution that can be used on personal computers, local area networks, local or remote proxy servers, Internet service providers, or search engines to control access to inappropriate content. Access to content is controlled by a filtering software administrator, who determines which sites and which contexts to restrict.

In a preferred embodiment, the systems and methods of the present invention involve a software solution consisting of five main components: (1) a configuration user interface; (2) a filtering software plug-in; (3) an Internet sites database; (4) a context database; and (5) a thesaurus database.

The configuration user interface consists of a set of configuration windows that enable the filtering software administrator to specify which sites and which contexts will be accessed by users. The filtering software administrator is a person in charge of controlling the access to electronic documents by users in a personal computer, local area network, or Internet service provider where the filtering software is being configured. The configuration user interface also enables the filtering software administrator to select a password so that the filtering software administrator is the only person allowed to specify how the users' access to electronic content will be monitored. The filtering software administrator may specify which sites and contexts will be restricted to users, or alternatively, which sites and contexts will be allowed access by users.

The filtering software plug-in is a software plug-in installed on a personal computer, local or remote proxy server, Internet service provider server, or search engine server to monitor access to electronic content. The electronic content may be displayed on web pages, newsgroups, e-mails, chat rooms, or any other document stored in electronic form, such as word processing documents, spreadsheets, presentations, among others. The filtering software plug-in may be installed as a plug-in to any application displaying electronic documents, such as a web browser, an e-mail application, a word processor, and a spreadsheet application, among others.

The filtering software plug-in implements the functions required to perform a contextual analysis of the electronic content to determine whether the content is to be restricted to users. In the case of content displayed on web pages, the filtering software plug-in checks whether the web page URL is a site specified by the filtering software administrator as a site that may be accessed by users prior to performing the contextual analysis on the web page. A sites database is provided to store a list of all the restricted or acceptable Internet sites specified by the filtering software administrator. The Internet sites include web sites, newsgroups, and chat rooms. Additionally, a contexts database is provided to store a list of all the restricted or acceptable contexts that may be conveyed in electronic documents accessed by users. Restricted contexts may be, for example, “pornography”, “sex”, “violence”, and “drugs”, among others.

A thesaurus database is provided to contain an extensive list of words and all the possible contexts in which the words may be used. When a user accesses an electronic document being monitored by the filtering software plug-in, the thesaurus database is used to create a list of contexts for all the relevant words in the document. In case the electronic document is a web page containing inappropriate pictures, the filtering software plug-in uses the picture file names and links displayed in the web page to perform the contextual analysis.

The contextual analysis consists of two steps. In the first step, the filtering software plug-in determines if the electronic document is dominated by any restricted contexts or pictures. The filtering software plug-in assigns a “context pertinence value” to each restricted context found in the document. The context pertinence value of a given context determines how many restricted words associated with that context are found in the document. Similarly, a “picture pertinence value” is assigned to each restricted context if the ratio of the number of pictures to the number of words in the document is more than 50%. The picture pertinence value determines how many restricted words associated with a given context are found in each link in the electronic document. If the context pertinence value or the picture pertinence value are above a pre-determined threshold specified by the filtering software administrator, then user's access to the electronic document is restricted. Otherwise, the second step of the contextual analysis is performed to further evaluate the content.

In the second step, the filtering software plug-in determines the most important contexts conveyed in the electronic document. Each word is assigned a weight that depends on how the word is displayed in the document. Each context is assigned a weight that depends on the number of words in the document that have the same context, the weight of those words, and the number of contexts for each one of those words. The contexts assigned the highest weight are determined to be the most important contexts. If the most important contexts are among the restricted contexts specified in the contexts database, the user is restricted access to the electronic document.

Advantageously, the present invention enables parents and computer users to filter electronic content based on the main idea of the content rather than on individual keywords. In addition, the present invention enables the filtering software administrator to filter web sites containing inappropriate pictures and inappropriate words spread out across links on the web sites.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic view of the system and the network environment in which the present invention operates;

FIG. 2 is a illustrative view of using the system and methods of the present invention to filter electronic documents accessed on a personal computer;

FIG. 3 is a schematic view of the software components of the present invention;

FIG. 4 is an illustrative view of a sites database used in accordance with the principles of the present invention;

FIG. 5 is an illustrative view of a contexts database used in accordance with the principles of the present invention;

FIG. 6 is an illustrative view of a thesaurus database used in accordance with the principles of the present invention;

FIG. 7 is an illustrative view of a dialog box for enabling a filtering software administrator to select a password for configuring the filtering software plug-in;

FIG. 8A is an illustrative view of a configuration window to enable a filtering software administrator to specify the electronic content to be restricted;

FIG. 8B is an illustrative view of a configuration window to enable a filtering software administrator to specify the electronic content that can be viewed by users;

FIG. 9 is an illustrative view of an interactive window for specifying contexts to be restricted to users;

FIG. 10 is an illustrative view of a window displaying all possible contexts that may be restricted by the filtering software administrator;

FIG. 11 is an illustrative view of an interactive window for specifying URLs to be restricted to users;

FIG. 12 is an illustrative view of a window to enable the filtering software administrator to type a URL to be restricted for viewing by users;

FIG. 13 is a flowchart for using the filtering software plug-in to filter out content displayed in an electronic document;

FIG. 14 is an illustrative view of a web browser window attempting to access a restricted URL;

FIG. 15 is an illustrative “denied access” web page;

FIG. 16 is an illustrative web page containing a restricted advertising banner;

FIG. 17 is an illustrative electronic document stored locally on a personal computer having the filtering software components; and

FIG. 18 is an exemplary list of relevant words extracted from the electronic document shown in FIG. 17 and their associated context and weight vectors.

### DETAILED DESCRIPTION OF THE INVENTION

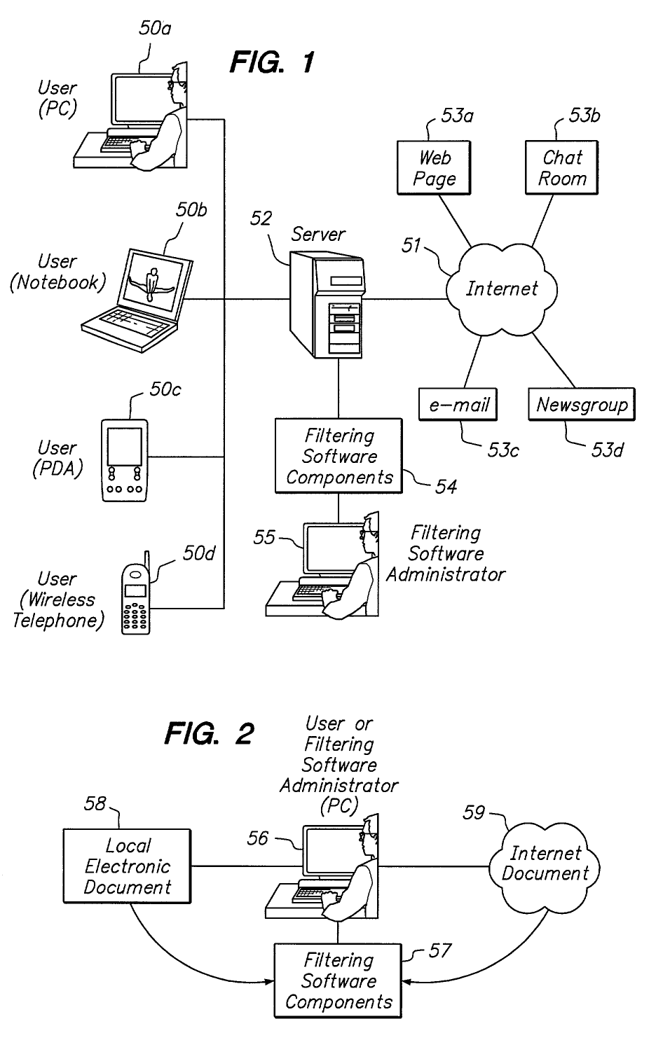

Referring to FIG. 1, a schematic view of the system and the network environment in which the present invention operates is described. Users 50a-d are connected to Internet 51 by means of server 52. User 50a connects to Internet 51 using a personal computer, user 50b connects to Internet 51 using a notebook computer, user 50c connects to Internet 51 using a personal digital assistant, and user 50d connects to Internet 51 using a wireless device such as a cellular phone. Server 52 may be a local proxy server on a local area network, a remote proxy server, or a web server of an Internet service provider. For example, users 50a-d may be employees of an organization or children in a school district connected to Internet 51 by means of a local area network.

Users 50a-d connect to Internet 51 to access and transmit electronic content in several forms, including web page 53a, messages in chat room 53b, e-mail 53c, and messages in newsgroup 53d. Users' 50a-d access to electronic content in Internet 51 is controlled by a filtering software installed on server 52. The filtering software consists of filtering software components 54, that are installed by filtering software administrator 55 on server 52. Filtering software administrator 55 is a person in charge of controlling the access to electronic content in Internet 51 by users 50a-d. Filtering software administrator 55 has a password to prevent users 50a-d or anyone else without the password to control how users 50a-d access Internet 51. It should be understood by one skilled in the art that one or more persons may share the role of filtering software administrator 55.

Whenever users 50a-d request electronic content from Internet 51, filtering software components 54 determine whether the content is acceptable for viewing by users 50a-d. If the content is restricted, then users 50a-d are displayed a message instead of the content saying that their access to the content has been restricted by filtering software administrator 55. Filtering software administrator 55 is responsible for specifying what kinds of electronic content may or may not be accessed by users 50a-d.

Referring now to FIG. 2, an illustrative view of using the system and methods of the present invention to filter electronic documents accessed on a personal computer is described. Personal computer 56 enables users to access local electronic document 58 stored on the computer's hard drive or on other storage media accessed by the computer, such as CDs, DVDs, and zip disks, among others. Local electronic document 58 consists of any document storing content in electronic form, such as word processing files, spreadsheets, and presentations, among others. Personal computer 56 also enables users to connect to the Internet to access Internet document 59, which may be a web page, a chat room transcript, a newsgroup message, an e-mail message, among others.

Personal computer 56 has filtering software components 57 to monitor access to local electronic document 58 and Internet document 59. Whenever a user requests local electronic document 58 or Internet document 59, filtering software components 57 checks the content of document 58 or document 59 to determine whether the content is appropriate for the user. A filtering software administrator having access to personal computer 56 is responsible for configuring filtering software components 57 to specify what kinds of content are appropriate for users of personal computer 56. For example, filtering software administrator 55 may be parents trying to monitor Internet usage by their children.

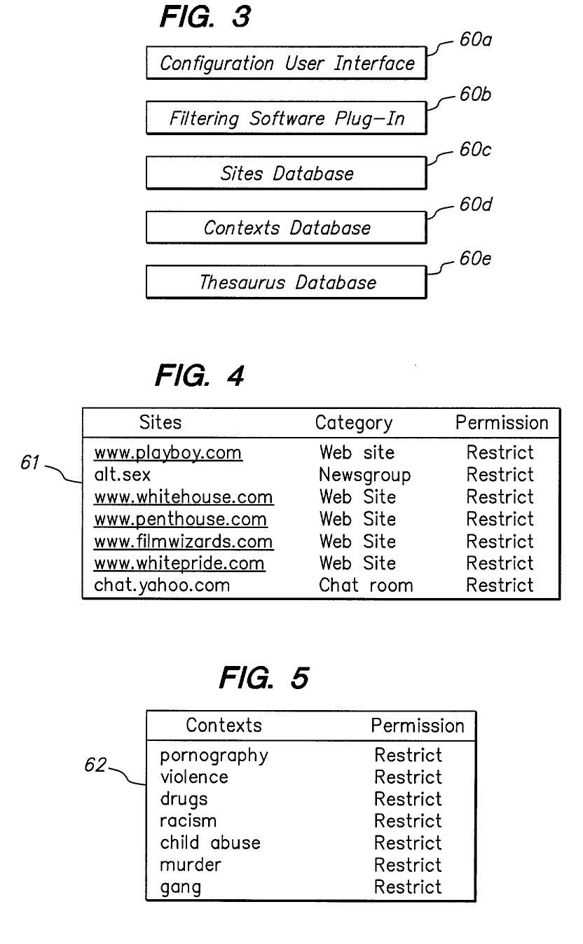

Referring now to FIG. 3, a schematic view of the software components of the present invention is described. The software components consist of: (1) configuration user interface 60a; (2) filtering software plug-in 60b; (3) sites database 60c; (4) contexts database 60d; and (5) thesaurus database 60d.

Configuration user interface 60a consists of a set of configuration windows that enable filtering software administrator 55 to specify what kinds of content are appropriate for users. Filtering software administrator 55 is a person in charge of controlling the access to electronic content by users in a personal computer, local area network, or Internet service provider where the filtering software is being configured. Configuration user interface 60a also enables filtering software administrator 55 to select a password so that the filtering software administrator is the only person allowed to specify how the users' access to electronic content will be monitored. Filtering software administrator 55 may specify which Internet sites and contexts in electronic documents will be restricted to users, or alternatively, which Internet sites and contexts in electronic documents will be allowed access by users.

Filtering software plug-in 60b is a software plug-in installed on a personal computer, local or remote proxy server, Internet service provider server, or search engine server to monitor access to electronic content. The electronic content may be displayed on web pages, newsgroups, e-mails, chat rooms, or any other document stored in electronic form, such as word processing documents, spreadsheets, presentations, among others. Filtering software plug-in 60b may be installed as a plug-in to any application displaying electronic documents, such as a web browser, an e-mail application, a word processor, a spreadsheet application, among others.

Filtering software plug-in 60b implements the functions required to perform a contextual analysis of the electronic content to determine whether the content is to be restricted to users. In the case of content displayed on web pages, filtering software plug-in 60b checks whether the web page URL is a site specified by filtering software administrator 55 as a site that may be accessed by users prior to performing the contextual analysis on the web page.

Sites database 60c is provided to store a list of all the restricted or acceptable Internet sites specified by filtering software administrator 55. The Internet sites include web sites, newsgroups, and chat rooms. Additionally, contexts database 60d is provided to store a list of all the restricted or acceptable contexts that may be conveyed in electronic documents accessed by users. Restricted contexts may be, for example, “pornography”, “sex”, “violence”, and “drugs”, among others.

Thesaurus database 60d is provided to contain an extensive list of words and all the possible contexts in which the words may be used. When a user accesses an electronic document being monitored by filtering software plug-in 60b, thesaurus database 60d is used to create a list of contexts for all the relevant words in the document. In case the electronic document is a web page containing inappropriate pictures, filtering software plug-in 60b uses the picture file names and links displayed in the web page to perform the contextual analysis. Filtering software plug-in 60b then analyzes the list of contexts for all the relevant words to determine the most important contexts conveyed in the electronic document. Each word is assigned a weight that depends on how the word is displayed in the document. Each context is assigned a weight that depends on the number of words in the document that have the same context, the weight of those words, and the number of contexts for each one of those words. The contexts assigned the highest weight are determined to be the most important contexts. If the most important contexts are among the restricted contexts specified in contexts database 60d, the user is restricted access to the electronic document.

Referring now to FIG. 4, an illustrative view of a sites database used in accordance with the principles of the present invention is described. Sites database 61 stores a list of URLs, newsgroups, and chat rooms that are restricted to users. Alternatively, sites database 61 may also store a list of URLs, newsgroups, and chat rooms that are available for user's access, in case filtering software administrator 55 desires to restrict access to all Internet sites except those listed in sites database 61. Sites database 61 contains a default list of restricted URLs, newsgroups, and chat rooms. The default list of URLs, newsgroups, and chat rooms may be modified at any time by filtering software administrator 55 by accessing configuration user interface 60a.

Referring now to FIG. 5, an illustrative view of a contexts database used in accordance with the principles of the present invention is described. Contexts database 62 stores a list of contexts that are restricted to users. If the contexts listed on contexts database 62 are extracted from an electronic document being accessed by an user, the user is restricted access to the document. Alternatively, contexts database 62 may also store a list of contexts that are acceptable to users, in case filtering software administrator 55 desires to restrict access to all contexts except those listed in contexts database 62. Contexts database 62 contains a default list of restricted contexts. The default list may be modified at any time by filtering software administrator 55 by accessing configuration user interface 60a. It should be understood by one skilled in the art that the contexts stored in contexts database 62 consist of semantic representations of words in the electronic documents.

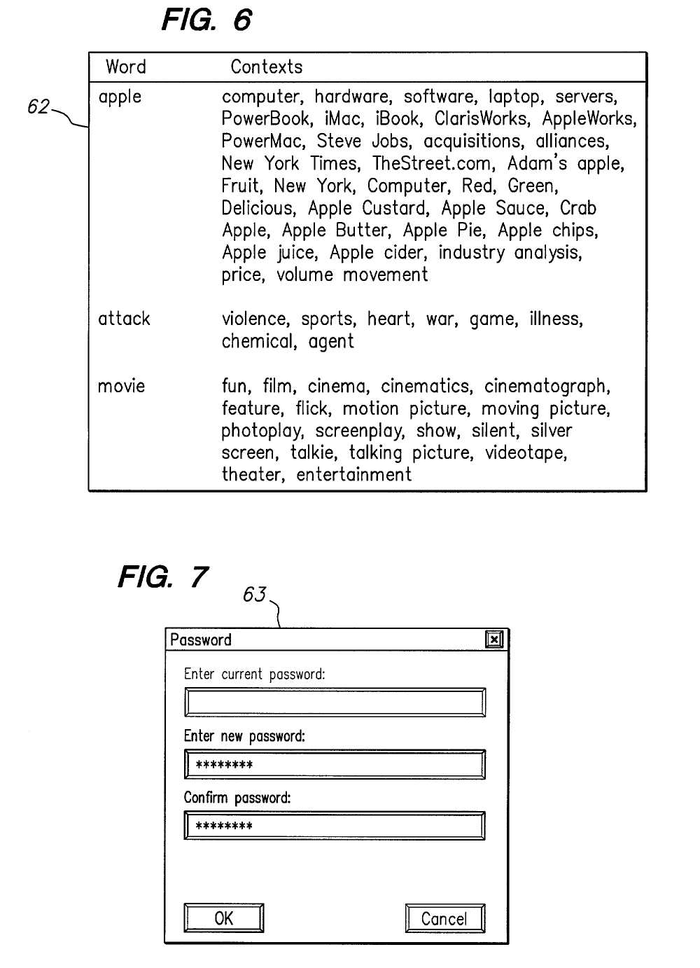

Referring now to FIG. 6, an illustrative view of a thesaurus database used in accordance with the principles of the present invention is described. Thesaurus database 63 stores an extensive list of words and the possible contexts in which the words may be used. A word such as “apple” may have its own contexts associated with it, or it may be listed as a context for other words, such as “fruit.”

I. Configuration User Interface

Referring now to FIG. 7, an illustrative view of a dialog box for enabling a filtering software administrator to select a password for configuring the filtering software plug-in is described. Dialog box 64 enables a filtering software administrator to select a password for accessing the configuration user interface for specifying the sites and contexts that will be restricted or allowed for the users. The password selected is known only to the filtering software administrator so that users are prevented from controlling their access to the Internet.

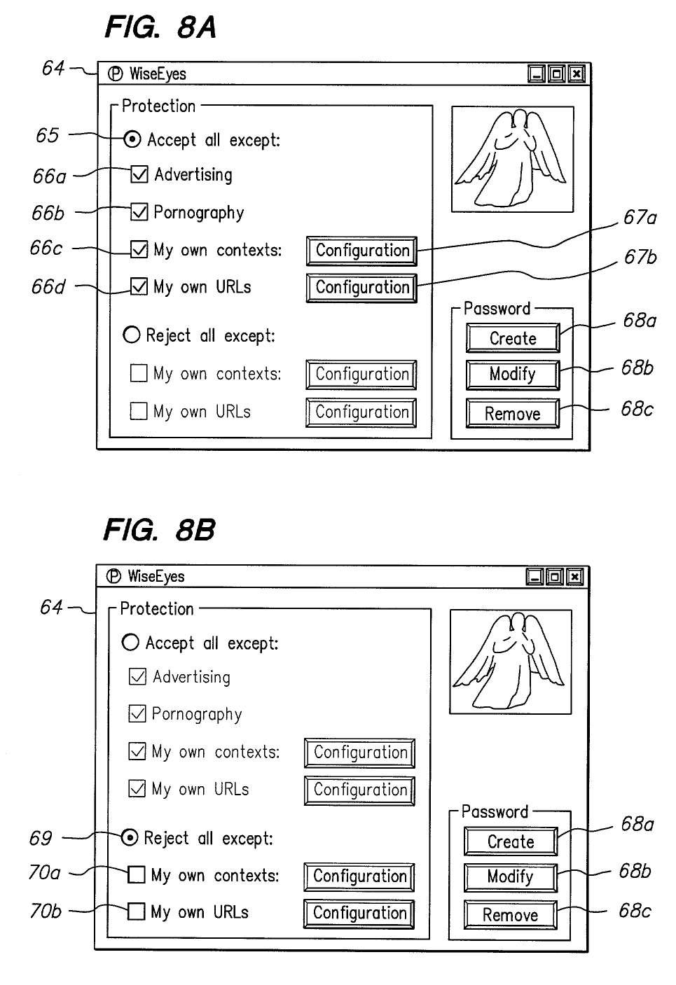

Referring now to FIG. 8A, an illustrative view of a configuration window to enable a filtering software administrator to specify the electronic content to be restricted is described. Configuration window 64 contains radio button 65 to enable the filtering software administrator to specify which sites and contexts will be restricted to users. When selected, radio button 65 lists buttons 66a-b that may be selected by the filtering administrator to automatically restrict two contexts in all electronic content assessed by the users, namely, “advertising” and “pornography.” By selecting the “advertising” context as a restricted context, the filtering software administrator is restricting access to advertising banners on web pages. When a user requests a web page containing an advertising banner, the filtering software plug-in replaces the banner with an icon representing a restricted area. By selecting the “pornography” context as a restricted context, the filtering software administrator is restricting access to all pornographic content displayed in electronic form.

Radio button 65 also lists button 66c to enable the filtering software administrator to select the contexts to be restricted to users. When selected, button 66c enables the filtering software administrator to click on button 67a to specify the contexts that will be restricted to users. In addition, radio button 65 lists button 66d to enable the filtering software administrator to select the URLs to be restricted to users. When selected, button 66d enables the filtering administrator to click on button 67b to specify the URLs that will be restricted to users. Configuration window 65 also contains buttons 68a-c to allow the filtering software administrator to manage the configuration password.

Referring now to FIG. 8B, an illustrative view of a configuration window to enable a filtering software administrator to specify the electronic content that can be viewed by users is described. Configuration window 64 contains radio button 69 to enable the filtering software administrator to restrict all sites and contexts except those specified as acceptable for viewing by users. When selected, radio button 69 lists button 70a to enable the filtering software administrator to select the acceptable contexts for viewing by users. In addition, radio button 69 lists button 70b to enable the filtering software administrator to select the URLs appropriate for viewing by users. Configuration window 64 also contains buttons 68a-c to allow the filtering software administrator to manage the configuration password.

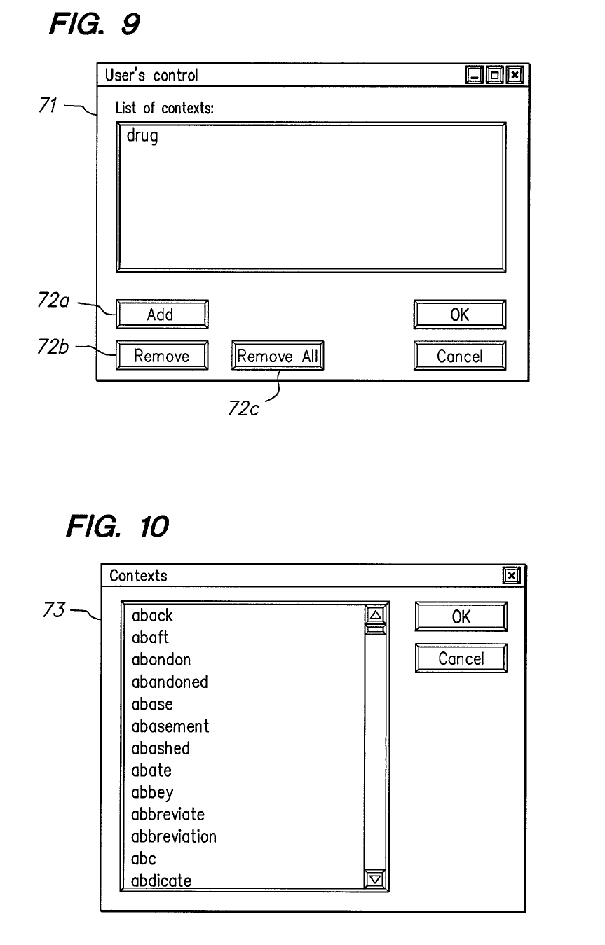

Referring now to FIG. 9, an illustrative view of an interactive window for specifying contexts to be restricted to users is described. Window 71 enables the filtering software administrator to specify a list of contexts to be restricted to users. Window 71 is displayed when the filtering software administrator selects button 67a in configuration window 64 shown in FIG. 8A. Window 71 contains buttons 72a-c to enable the filtering software administrator to add (72a), remove (72b), or remove all (73c) contexts in the list. The list of contexts entered in window 71 is stored in contexts database 60d. When the filtering software administrator clicks on button 72a to add contexts to the list of restricted contexts, a window is displayed showing all contexts that may be selected.

Referring now to FIG. 10, an illustrative view of a window displaying all possible contexts that may be restricted by the filtering software administrator is described. Window 73 enables the filtering software administrator to highlight the contexts to be restricted to users and add those contexts to contexts database 60d.

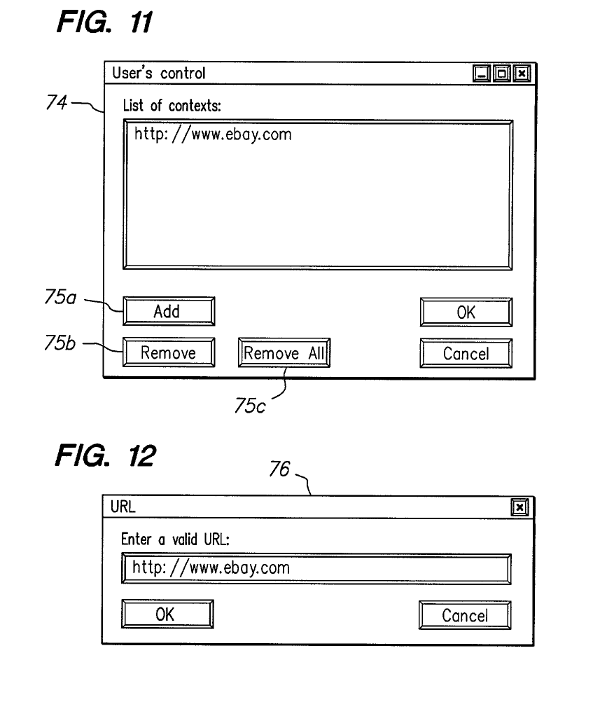

Referring now to FIG. 11, an illustrative view of an interactive window for specifying URLs to be restricted to users is described. Window 74 enables the filtering software administrator to specify a list of URLs to be restricted to users. Window 74 is displayed when the filtering software administrator selects button 67b in configuration window 64 shown in FIG. 8A. Window 74 contains buttons 75a-c to enable the filtering software administrator to add (75a), remove (75b), or remove all (75c) URLs in the list. The list of URLs entered in window 74 is stored in sites database 60c. When the filtering software administrator clicks on button 75a to add URLs to the list of restricted URLs, a window is displayed to enable the filtering software administrator to type a URLs to be restricted for viewing by users.

Referring now to FIG. 12, an illustrative view of a window to enable the filtering software administrator to type a URL to be restricted for viewing by users is described. Window 76 enables the filtering software administrator to enter a URL to be restricted to users. The URL to be restricted is then stored in sites database 60c.

II. Filtering Software Plug-In

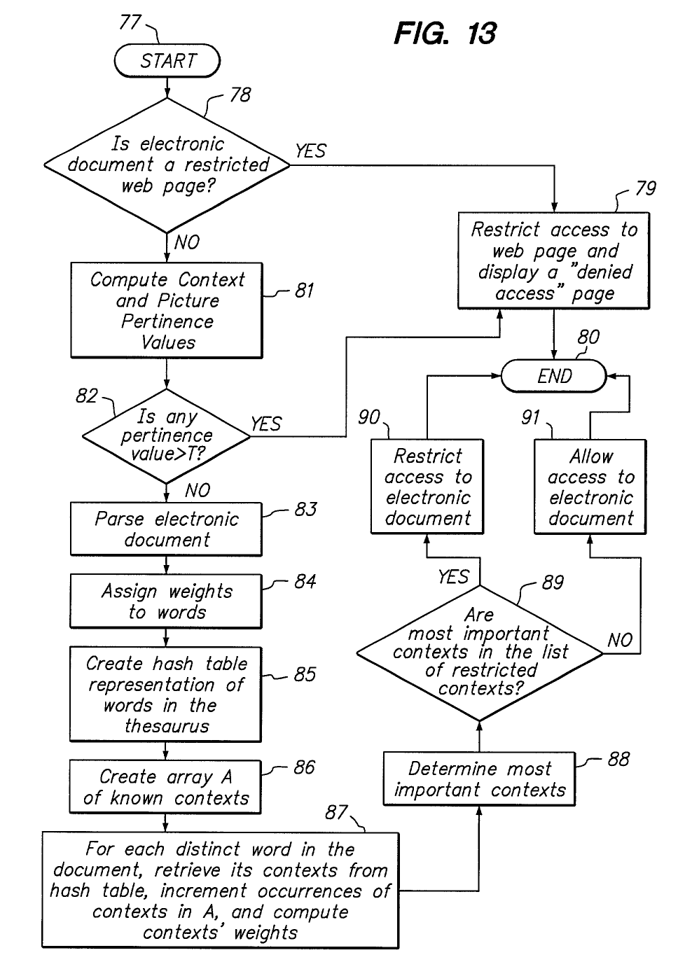

Referring now to FIG. 13, a flowchart for using the filtering software plug-in to filter out content displayed in an electronic document being accessed by a user is described. The electronic document may be a web page, a chat room transcript, a newsgroup transcript, a word processing document, and a spreadsheet, among others. At step 78, filtering software plug-in 60b checks whether the electronic document being accessed by a user is a web page specified in sites database 60d as a restricted web page. If the electronic document is specified as a restricted page, then filtering software plug-in 60b restricts access to the web page at step 79 and displays a web page to the user with a “denied access” message. Otherwise, if the electronic document is not a restricted web page, filtering software plug-in 60b computes a “context pertinence value” for each restricted context found in the document. The context pertinence value of a given context determines how many restricted words associated with that context are found in the document. For document i and context c, the context pertinence value CP_{i,c} is computed as:

$${CP}_{i , c} = {\sum }_{j = 1}^{M} {C}_{i , j}$$

where C_{i,j} is an index equal to one for each occurrence j of context c in document i. For example, in case document i is a web page containing pornographic material and context c is the “pornography” context, CP_{i,c} is equal to the number of words associated with that context.

Similarly, a “picture pertinence value” is assigned to each restricted context if the ratio of the number of pictures to the number of words in the document is more than 50%. The picture pertinence value determines how many restricted words associated with a given context are found in each link in the electronic document. For document i and context c, the picture pertinence value PP_{i,c} is computed as:

$${PP}_{i , c} = {\sum }_{k = 1 , k \neq i}^{N} ( {L}_{i , k} {\sum }_{j = 1}^{M} {C}_{k , j} )$$

where C_{k,j} is an index equal to one for each occurrence j of context c in link L_{i,k}.

If filtering software plug-in 60b determines at step 82 that a context pertinence value or a picture pertinence value is above a pre-determined threshold specified by the filtering software administrator, then user's access to the electronic document is restricted at step 79.

Otherwise, at step 83, filtering software plug-in 60b parses the electronic document to extract the relevant words that may represent the main idea conveyed in the document. The relevant words include all words in the document except for articles, prepositions, individual letters, and other document specific tags, such as HTML tags included in web pages.

At step 84, filtering software plug-in 60b assigns a weight to each relevant word extracted at step 83. Each relevant word extracted is assigned a default weight of one, and this weight is modified according to how the word is displayed in the electronic document. The weight is used to attach an importance value to each word extracted according to various formatting parameters, including: (1) the number of times the word appears in the document; (2) the total number of words in the document; (3) the format of the word in the document, i.e., whether the word displayed is in bold, italics, capitalized, etc.; (4) whether the word is in a different format from the surrounding words; (5) whether the word is part of the header or meta tags of a web page; and (6) whether the electronic document has been rated by a rating service compliant with the PICS standard.

At step 85, a hash table representation of the words in the document is created. At step 86, an array A of known contexts is created for each relevant word extracted at step 83. The hash table representation is used to speed up the process of finding words and their contexts in thesaurus database 60d. Each word is assigned an index value that is linked to the array A of contexts associated with the word. Each context associated with a given word is also assigned an index value and a number of occurrences in the document, so that instead of searching for contexts in thesaurus database 60d, filtering software plug-in 60b simply performs a hash table look-up operation.

At step 87, for each distinct word in the document, filtering software plug-in 60b retrieves the word's contexts from the hash table, finds all occurrences of the context in the electronic document and increments the occurrences of the contexts in array A, and finally, calculates the contexts' weights. The weight of a given context depends on the number of words in the document associated with that context, the weight of those words, and the number of contexts for each one of those words. The weight P_{i,c} of context c in document i is calculated as:

$${P}_{i , c} = {\sum }_{j = 1}^{W} \frac{{PW}_{j}}{{NC}_{j}}$$

where W is the number of words in document i associated with context c, PWⱼ is the weight of the word j associated with context c, and NCⱼ is the number of contexts associated with word j.

At step 88, filtering software plug-in 60b determines the five most important contexts in the document to extract the semantic meaning of the document. The five most important contexts are the contexts that have the higher weight. At step 89, filtering software plug-in 60b determines whether any of the most important contexts are part of the restricted contexts stored in contexts database 60c. If any of the most important contexts is a restricted context, filtering software plug-in restricts the access to the electronic document at step 90. Otherwise, filtering software plug-in allows access to the electronic document at step 91.

It should be understood by one skilled in the art that filtering software plug-in 60b may prevent users from sending inappropriate electronic documents to others through the Internet or other storage media. Further, filtering software plug-in 60b may be used to determine what web sites users are visiting, how much time users are spending on any given web site, detect what types of document are being accessed or transmitted by users (e.g., filtering software plug-in 60b may determine whether an user is transmitting C or C++ source code to other users), and finally, restrict the transmission or access of documents considered inappropriate by the filtering software administrator.

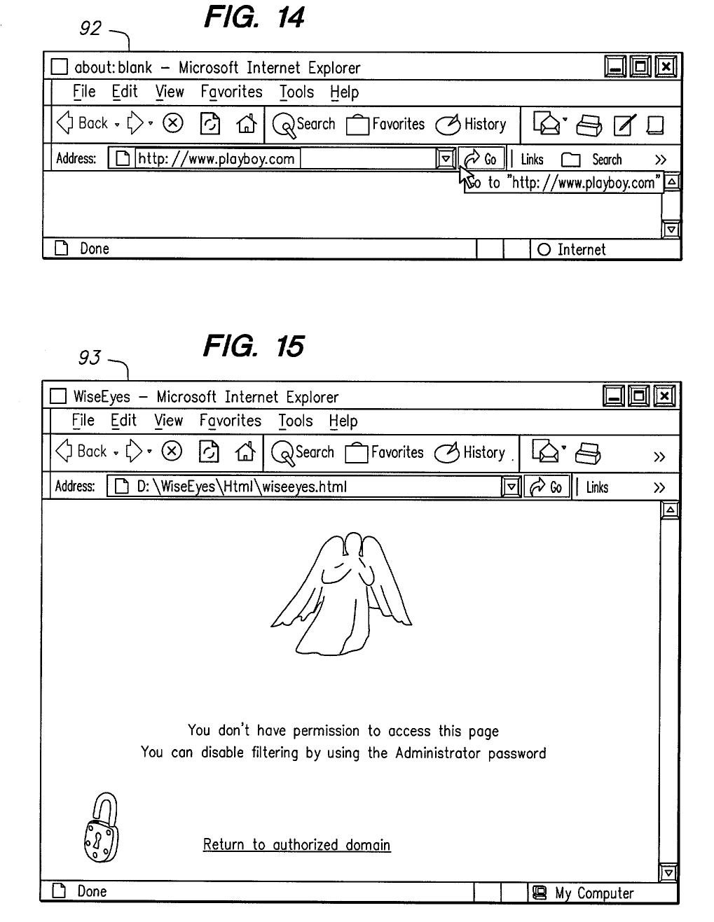

Referring now to FIG. 14, an illustrative view of a web browser window attempting to access a restricted URL is described. Web browser window 92 contains a URL address field in which a user types a desired URL to be accessed. When the user types a URL in the address field, filtering software plug-in 60b is triggered to filter the content displayed in the URL to determine its appropriateness for viewing by the user. Filtering software plug-in 60b first checks whether the URL is part of the list of restricted URLs stored in sites database 60c. If the URL is a restricted URL, filtering software plug-in 60b displays a “denied access” page instead of the page trying to be accessed.

Referring now to FIG. 15, an illustrative “denied access” web page is described. Web page 93 is displayed to users whenever users attempt to access a restricted URL. Web page 93 displays a message to users saying that they don't have permission to access that URL. Web page 93 also informs users that the access to that particular restricted URL can be controlled by the filtering software administrator.

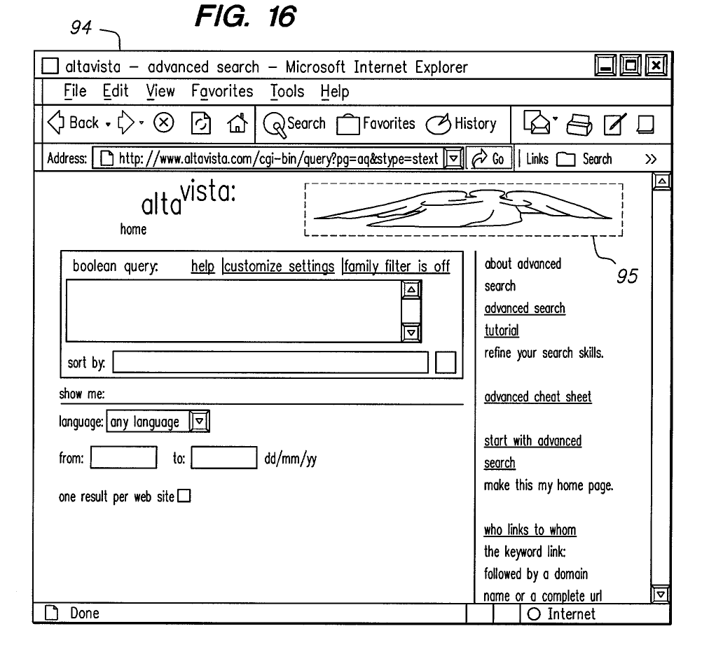

Referring now to FIG. 16, an illustrative web page containing a restricted advertising banner is described. Web page 94 contains advertisement banners, which are included in the list of restricted contexts stored in contexts database 60d. When an user accesses web page 94, filtering software plug-in 60b parses the web page to extract its main contexts and finds that the advertisement context is present on web page 94. Filtering software plug-in 60b then replaces the advertising banner with “denied access” banner 95.

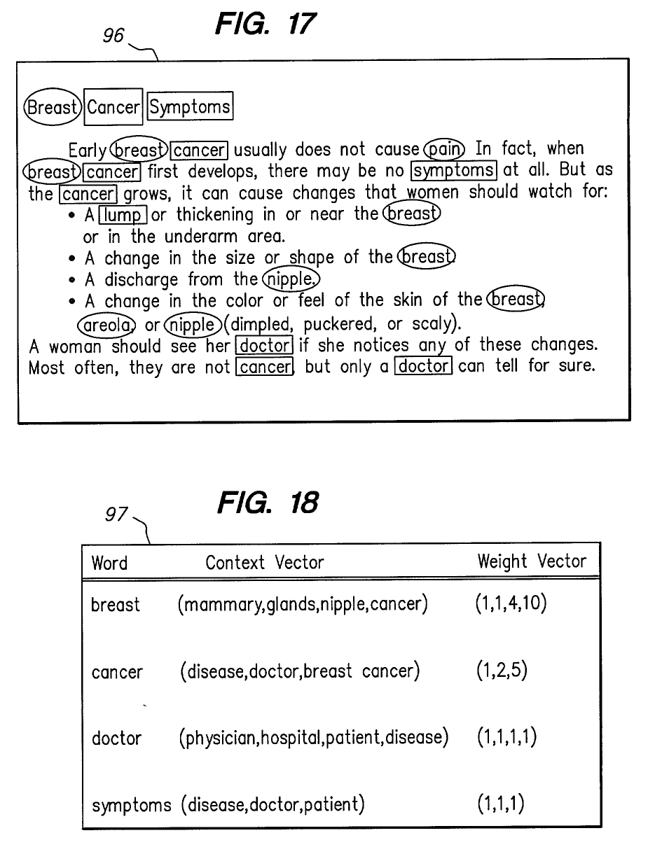

Referring now to FIG. 17, an illustrative electronic document stored locally on a personal computer having the filtering software components is described. Electronic document 96 is a word processing document containing a description of symptoms of breast cancer. The description lists several words that may be considered inappropriate when used in a different context, including the words “breast”, “nipple”, “pain”, and “areola” (these words are highlighted inside a circle). However, the description also contains words such as “cancer”, “symptoms”, “doctor”, and “lump” that indicate that the main idea of the electronic document is associated with breast cancer. When filtering software plug-in 60b analyses electronic document 96 to evaluate whether its content is appropriate to users, the main idea of electronic document 96 is extracted and the user is allowed access to document 96.

Referring now to FIG. 18, an exemplary list of relevant words extracted from the electronic document shown in FIG. 17 and their associated context and weight vectors is described. The words “breast”, “cancer”, “doctor”, and “symptoms” were extracted from electronic document 96 by filtering software plug-in 60b. Each one of these words has a context vector and a weight vector associated with it. The context vector lists all contexts found for that word in thesaurus database 60e. Based on these contexts and how the words are displayed in electronic document 96, filtering software plug-in 60b computes the contexts' weights in a weight vector associated with the context vector.

Based on the weight vectors, filtering software plug-in 60b determines that the most important contexts that represent the semantic meaning of document 96 are the “cancer”, “breast cancer”, “nipple”, and “doctor” contexts. Filtering software plug-in 60b is then able to determine that the main idea conveyed in document 96 is about “breast cancer” rather than, say, an erotic story.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for filtering an electronic document to determine whether content in the electronic document is inappropriate to users, the method comprising:
parsing the electronic document to extract the relevant words in the document;
assigning a weight to each relevant word in the document;
extracting a plurality of contexts for each relevant word in the document from a thesaurus dictionary;
assigning a weight to each context in the plurality of contexts;
determining which contexts in the plurality of contexts are the most important contexts in the document; and
restricting access to the electronic document if the most important contexts in the document are in a list of restricted contexts.

2. The method of claim 1, further comprising restricting access to the electronic document if the electronic document is a web page and the web page is in a list of restricted web pages.

3. The method of claim 1, wherein assigning a weight to each relevant word in the document comprises assigning a weight according to one or more formatting parameters selected from a group of formatting parameters consisting of: number of times the relevant word appears in the document; total number of words in the document; format of the relevant word in the document; format of a plurality of words surrounding the relevant word in the document; header or meta tag associated with the relevant word if the electronic document is a web page; and PICS rating associated with the document.

4. The method of claim 1, wherein extracting a plurality of contexts for each relevant word in the document from a thesaurus dictionary comprises creating a context vector for each relevant word in the document comprising the plurality of contexts found in the thesaurus dictionary.

5. The method of claim 1, wherein assigning a weight to each context in the plurality of contexts comprises determining the number of words in the document having the same context and the number of contexts associated with each word in the document.

6. The method of claim 5, wherein the weight is based on the weight of the relevant word; the number of words in the document having the same context; and the number of contexts associated with each word in the document.

7. The method of claim 1, wherein determining which contexts in the plurality of contexts are the most important contexts in the document comprises determining which contexts in the plurality of contexts have the highest weight.

8. The method of claim 1, wherein restricting access to the electronic document if the most important contexts in the document are in a list of restricted contexts comprises displaying a message to the user notifying the user that the document has inappropriate content.

9. A method for filtering an electronic document to determine whether content in the electronic document is inappropriate to users, the method comprising:
checking whether the electronic document is in a list of restricted electronic documents;
determining whether the electronic documents contains an unacceptable number of inappropriate words or pictures;
extracting a plurality of contexts for each word in the document from a thesaurus dictionary;
assigning a weight to each context in the plurality of contexts;
determining which contexts in the plurality of contexts are the most important contexts in the document; and
restricting access to the electronic document if the most important contexts in the document are in a list of restricted contexts.

10. The method of claim 9, wherein the electronic document comprises one or more electronic documents selected from a group consisting of: a web page; a newsgroup transcript; a chat room transcript; an e-mail; a document in a CD; a document in a DVD; and a document in a disk.

11. The method of claim 9, wherein determining whether the electronic documents contains an unacceptable number of inappropriate words or pictures comprises determining a ratio of pictures to words in the document and determining the number of inappropriate words in a plurality of links in the document if the ratio exceeds fifty percent.

12. The method of claim 9, wherein assigning a weight to each context in the plurality of contexts comprises determining the number of words in the document having the same context and the number of contexts associated with each word in the document.

13. The method of claim 9, wherein determining which contexts in the plurality of contexts are the most important contexts in the document comprises determining which contexts in the plurality of contexts have the highest weight.

14. A system for filtering an electronic document to determine whether content in the electronic document is inappropriate to users, the system comprising:
a configuration user interface for allowing a filtering software administrator to control the users' access to electronic documents;
a filtering software plug-in to monitor users' access to electronic documents;
an Internet sites database storing a list of inappropriate sites;
a context database storing a list of restricted contexts; and
a thesaurus database storing a thesaurus dictionary.

15. The system of claim 14, wherein the the electronic document comprises one or more electronic documents selected from a group consisting of: a web page; a newsgroup transcript; a chat room transcript; an e-mail; a document in a CD; a document in a DVD; and a document in a disk.

16. The system of claim 14, wherein the configuration user interface comprises a user interface for specifying which sites and contexts are inappropriate to users.

17. The system of claim 14, wherein the filtering software plug-in performs a contextual analysis of the electronic document to determine whether the electronic document is inappropriate to users.

18. The system of claim 17, wherein the contextual analysis comprises determining the main contexts of the electronic document.

19. The system of claim 18, wherein the main contexts of the electronic document comprise the contexts assigned a higher weight.

20. The system of claim 19, wherein the weight comprises a value assigned to a context extracted from the thesaurus database, the value depending on one or more parameters selected from a group of parameters consisting of: number of words having the same context; weights of the words having the same context; and number of words in the document.
